(19) United States
(12) Patent Application Publication
(10) Pub. No.: US 2023/0015100 A1
(43) Pub. Date: Jan. 19, 2023

(54) INTELLIGENT WATER SUPPLY BASE FOR USE IN PLANTING POT

(71) Applicant: Wuhan Muchun Intelligent Technology Co. , Ltd., Wuhan (CN)

(72) Inventors: Yang LI, Wuhan (CN); Hao WANG, Wuhan (CN); Cheng FANG, Wuhan (CN)

(73) Assignee: Wuhan Muchun Intelligent Technology Co. , Ltd., Wuhan (CN)

(21) Appl. No.: 17/790,764

(22) PCT Filed: Jan. 15, 2021
(86) PCT No.: PCT/CN2021/071977

§ 371 Date: Jul. 5, 2022

(30) Foreign Application Priority Data
Jan. 17, 2020 (CN) 202020107820.1

(51) Int. Cl. A01G 27/00

(52) U.S. Cl. CPC A01G 27/003

(57) ABSTRACT

The present utility model provides an intelligent water supply seat for a planting pot, including a shell, a controller, a battery, a humidity sensor, a power source and a pipeline. The shell is internally provided with a water storage cavity. The controller and the battery are both installed in the shell and isolated from the water storage cavity. The humidity sensor is electrically connected with the controller and extends out of the shell. The power source is installed in the water storage cavity. The pipeline is connected with the power source and extends out of the shell. The controller is electrically connected between the battery and the power source. The humidity sensor is configured for detecting the humidity of soil in the planting pot on the intelligent water supply seat for the planting pot. The power source conveys water in the water storage cavity into the planting pot on the intelligent water supply seat for the planting pot through the pipeline.

### TECHNICAL FIELD

The present utility model relates to the technical, field of planting pots, in particular to an intelligent water supply seat for a planting pot.

### BACKGROUND

Some potted plants are often planted in some outdoor public areas, but non-intelligent planting pots need to be watered artificially and irregularly, so that when watering is not timely or insufficient, plants in the planting pots are easy to wither; and when the watering is excessive, water in the planting pots easily overflows to remain sewage and breed insects in trays for the planting pots and influence the attractiveness of the planting pots.

In view of this, it is necessary to provide a novel intelligent water supply seat for a planting pot to overcome the above drawbacks.

### SUMMARY

An objective of the present utility model is to provide an intelligent water supply seat for a planting pot, which may detect and supply water according to the volume of the water in the planting pot, so as to prevent plants in the planting pot from withering and prevent the water in the planting pot from overflowing to remain sewage and breed insects in a tray for the planting pot and influence the attractiveness of the planting pot.

In order to achieve the objective, the present utility model provides an intelligent water supply seat for a planting pot, including a shell 1, a controller 2, a battery 3, a humidity sensor 4, a power source 5 and a pipeline 6, wherein the shell 1 is internally provided with a water storage cavity 11, the controllers 2 and the battery 3 are both installed in the shell 1 and isolated from the water storage cavity 11, the humidity sensor 4 is electrically connected with the controller 2 and extends out of the shell 1, the power source 5 is installed in the water storage cavity 11, the pipeline 6 is connected with the power source 5 and extends out of the shell 1, the controller 2 is electrically connected between the battery 3 and the power source 5, the humidity sensor 4 is configured for detecting the humidity of soil in the planting pot on the intelligent water supply seat for the planting pot, and the power source 5 conveys water in the water storage cavity 11 to the planting pot on the intelligent water supply seat for the planting pot through the pipeline 6.

In a preferred embodiment, a solar panel 12 is disposed on the shell 1, and the solar panel 12 is electrically connected with the battery 3.

In a preferred embodiment, the intelligent water supply seat for the planting pot further includes a liquid level sensor 7, and the liquid level sensor 7 is installed in the water storage cavity 11 and is electrically connected with the controller 2.

In a preferred embodiment, a top surface of the shell 1 is provided with a liquid inlet 13.

In a preferred embodiment, a start/stop button 14 is disposed on the shell 1, and the start/stop button 14 is electrically connected between the controller 2 and the battery 3.

In a preferred embodiment, a liquid level display bar 15 is disposed on the shell 1, and a dial gauge is disposed on the liquid level display bar 15.

In a preferred embodiment, the solar panel 12 is disposed on a side wall of the shell 1, the start/stop button 14 is disposed on a side wall of the shell 1, and the liquid level display bar 15 is disposed on a side wall of the shell 1.

In a preferred embodiment, the controller 2 is a single-chip microcomputer, the power source 5 is a pump, and the pipeline 6 is a polyethylene (PC) water supply pipe.

In a preferred embodiment, a wireless connection device is disposed on the controller 2.

Compared with the prior art, the intelligent water supply seat for the planting pot provided by the present utility model has the beneficial effects that the humidity sensor, the controller and the power source are disposed, and the shell is provided with the water storage cavity; and the humidity sensor may detect the volume of the water in the planting pot, and the controller supplies the water by itself according to the volume of the water detected by the humidity sensor, so as to prevent plants in the planting pot from withering and prevent the water in the planting pot from overflowing to remain sewage and breed insects in a tray for the planting pot and influence the attractiveness of the planting pot.

### BRIEF DESCRIPTION OF THE DRAWINGS

In order to more clearly describe the technical solutions of the embodiments of the present utility model, the accompanying drawings required to be used in the embodiments will be briefly introduced below. It should be understood that the following accompanying drawings only show some embodiments of the present utility model, and therefore should not be considered as limiting the scope. Those skilled in the art may also derive other related accompanying drawings from these accompanying drawings without creative efforts.

FIG. 1 is a schematic structural diagram of an intelligent water supply seat for a planting pot provided by the present utility model.

### DETAILED DESCRIPTION OF THE EMBODIMENTS

In order to make the objectives, technical solutions and advantageous technical effects of the present utility model more clearly understood, the present utility model is further described in detail below with reference to the accompanying drawings and the specific implementations. It should be understood that the specific implementations described in this description are only for explaining the present utility model, not for limiting the present utility model.

It is to be understood that the orientation or positional relationships indicated by the terms “upper”, “lower”, “front”, “rear”, “left” “right”, “top”, “bottom”, “inner”, “outer” and the like are based on the orientation or positional relationships shown in the accompanying drawings, which are only for conveniently describing the present utility model and simplifying the description, rather than indicating or implying that the referred device or element must have a particular orientation and be constructed and operated in the particular orientation, and thus should not be construed as limiting the present utility model.

It is also to be noted that, unless otherwise expressly specified or limited, the terms “installed”, “connected”, “connection”, “fixed”, “disposed” and the like should be understood in a broad sense. For example, the connection may be a fixed connection, a detachable connection, or an integration; the connection may be a mechanical or electrical connection; and the connected may be directly connected, indirectly connected through an intermediate medium, communication between the interiors of two elements or an interactive relationship between the two elements. For those of ordinary skill in the art, specific meanings of the above terms in the present utility model may be determined according to specific circumstances.

Furthermore, the terms “first” and “second” are used for descriptive purposes only and should not be construed as indicating or implying relative importance or implicitly indicating the number of indicated technical features. Thus, a feature defined as “first” or “second” may explicitly or implicitly include one or more features. In addition, the meaning of “a plurality of” or “multiple” refers to two or more, unless otherwise specifically limited.

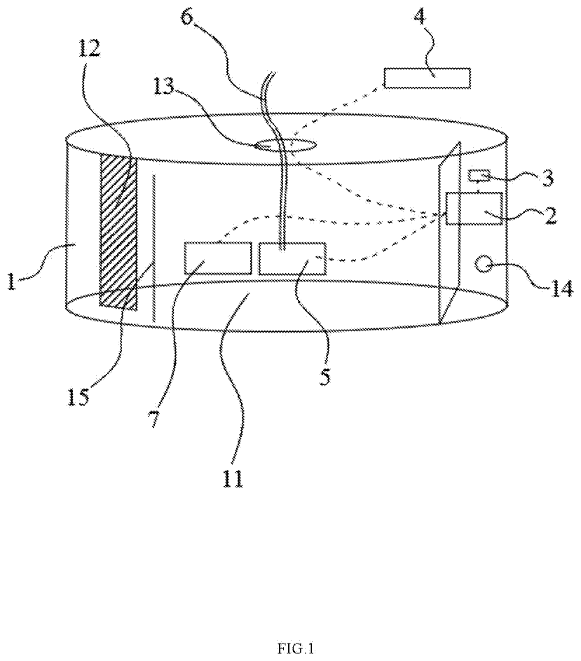

Referring to FIG. 1, the present utility model provides an intelligent water supply seat for a planting pot, including a shell 1, a controller 2, a battery 3, a humidity sensor 4, a power source 5 and a pipeline 6, wherein the shell 1 is internally provided with a water storage cavity 11, the controller 2 and the battery 3 are both installed in the shell 1 and isolated from the water storage cavity 11, the humidity sensor 4 is electrically connected with the controller 2 and extends out of the shell 1, the power source 5 is installed in the water storage cavity 11, the pipeline 6 is connected with the power source 5 and extends out of the shell 1, the controller 2 is electrically connected between the battery 3 and the power source 5, the humidity sensor 4 is configured for detecting the humidity of soil in the planting pot placed on the intelligent water supply seat for the planting pot, and the power source 5 conveys water in the water storage cavity 11 to the planting pot on the intelligent water supply seat for the planting pot, through the pipeline 6. In this embodiment, the controller 2 is a single-chip microcomputer, the power source 5 is a pump, and the pipeline 6 is a polyethylene (PE) water supply pipe.

When the planting pot is placed on the intelligent water supply seat for the planting pot, the pipeline 6 and the humidity sensor 4 are extended into the soil in the planting pot, and when the humidity sensor 4 detects that the volume of the water of the soil in the planting pot is too small, the controller 2 sends out an instruction to start the power source 5 to convey the water in the water storage cavity 11 into the planting pot through the pipeline 6 to supply the water to plants in the planting pot so as to prevent the plants from withering; and when a watering amount reaches a set value, the controller 2 immediately sends out an instruction to stop the power source 5. A liquid inlet 13 may prevent the water in the planting pot from overflowing to remain sewage and breed insects in a tray for the planting pot and influence the attractiveness of the planting pot.

Further, a solar panel 12 is disposed on a side wall of the shell 1, the solar panel 12 is electrically connected with the battery 3, and the solar panel 12 is configured for converting light energy into electric energy and charging the battery 3 with the converted electric energy.

Further, the intelligent water supply seat for the planting pot further includes a liquid level sensor 7, the liquid level sensor 7 is installed in the water storage cavity 11 and is electrically connected with the controller 2, and the liquid level sensor 7 is configured for detecting a liquid level of water stored in the water storage cavity 11.

Further, the shell 1 is cylindrical, and a top surface of the shell is provided with the liquid inlet 13 communicating with the water storage cavity 11. In this way, when the water in the planting pot overflows, the water may flow back to the water storage cavity 11 from the liquid inlet 13.

Further, a start/stop button 14 is disposed on a side wall of the shell 1, the start/stop button 14 is electrically connected between the controller 2 and the battery 3, and a working state and a shutdown state of the intelligent water supply seat for the planting pot may be controlled by pressing the start/stop button 14.

Further, a transparent liquid level display bar 15 is disposed on a side wall of the shell 1, and a dial gauge is disposed on the liquid level display bar 15. In this way, the volume of the water in the water storage cavity 11 may be visually seen through the liquid level display bar 15.

Further, a wireless connection device (not shown in figure) is disposed on the controller 2, and the wireless connection device is configured for performing a wireless communication connection with a mobile phone. In this way, the multifunctional planting pot may be remotely controlled through an app of the mobile phone.

The beneficial effects are that the humidity sensor, the controller and the power source are disposed, and the shell is provided with the water storage cavity; and the humidity sensor may detect the volume of the water in the planting pot, and the controller supplies the water by itself according to the volume of the water detected by the humidity sensor so as to prevent plants in the planting pot from withering and prevent the water in the planting pot from overflowing to remain sewage and breed insects in a tray for the planting pot and influence the attractiveness of the planting pot.

The present utility model is not limited only to what is described in the description and implementations, so that those skilled in the art may easily realize other advantages and modifications, and the present utility model is not limited to specific details, representative apparatuses and graphic examples shown and described herein without departing from the spirit and scope of the general concept defined by the claims and equivalent scope.

1. An intelligent water supply seat for a planting pot, comprising a shell (1), a controller (2), a battery (3), a humidity sensor (4), a power source (5) and a pipeline (6), wherein the shell (1) is internally provided with a water storage cavity (11), the controller (2) and the battery (3) are both installed in the shell (1) and isolated from the water storage cavity (11), the humidity sensor (4) is electrically connected with the controller (2) and extends out of the shell (1), the power source (5) is installed in the water storage cavity (11), the pipeline (6) is connected with the power source (5) and extends out of the shell (1), the controller (2) is electrically connected between the battery (3) and the power source (5) the humidity sensor (4) is configured for detecting the humidity of soil in the planting pot on the intelligent water supply seat for the planting pot, and the power source (5) conveys water in the water storage cavity (11) to the planting pot on the intelligent water supply seat for the planting pot through the pipeline (6).

2. The intelligent water supply seat for a planting pot according to claim 1, wherein a solar panel (12) is disposed on the shell (1), and the solar panel (12) is electrically connected with the battery (3).

3. The intelligent water supply seat for a planting pot according to claim 1, further comprising a liquid level sensor (7), wherein the liquid level sensor (7) is installed in the water storage cavity (11) and electrically connected with the controller (2).

4. The intelligent water supply seat for a planting pot according to claim 1, wherein a top surface of the shell (1) is provided with a liquid inlet (13).

5. The intelligent water supply seat for a planting pot according to claim 1, wherein a start/stop button (14) is disposed on the shell (1), and the start/stop button (14) is electrically connected between the controller (2) and the battery (3).

6. The intelligent water supply seat for a planting pot according to claim 1, wherein a liquid level display bar (15) is disposed on the shell (1), and a dial gauge is disposed on the liquid level display bar (15).

7. The intelligent water supply stand for a planting pot according to claim 1, wherein a solar panel (12) is disposed on a side wall of the shell (1), a start/stop button (14) is disposed on a side wall of the shell (1) and a liquid level display bar (15) is disposed on a side wall of the shell (1).

8. The intelligent water supply seat for a planting pot, according to claim 1, wherein the controller (2) is a single-chip microcomputer, the power source (5) is a pump, and the pipeline (6) is a polyethylene (PE) water supply pipe.

9. The intelligent water supply stand for a planting pot according to claim 1, wherein a wireless connection device is disposed on the controller (2).
